(19) United States
(12) Patent Application Publication
(10) Pub. No.: US 2016/0305359 A1
(43) Pub. Date: Oct. 20, 2016

(54) FUEL INJECTION CONTROL DEVICE

(71) Applicants: TOYOTA JIDOSHA KABUSHIKI KAISHA, Toyota-shi, Aichi-ken (JP); AISAN KOGYO KABUSHIKI KAISHA, Obu-shi, Aichi-ken (JP)

(72) Inventors: Takao Komoda, Okazaki-shi (JP); Shoichiro Takekawa, Nagoya-shi (JP)

(73) Assignees: TOYOTA JIDOSHA KABUSHIKI KAISHA, Toyota-shi, Aichi-ken (JP); AISAN KOGYO KABUSHIKI KAISHA, Obu-shi, Aichi-ken (JP)

(21) Appl. No.: 15/100,359

(22) PCT Filed: Nov. 28, 2014
(86) PCT No.: PCT/IB2014/002587

§ 371 Date: May 31, 2016

(30) Foreign Application Priority Data
Nov. 29, 2013 (JP) 2013-248357

(51) Int. Cl. F02D 41/24; F02M 21/02; F02D 41/00; F02D 41/06; F02D 19/02; F02D 19/08

(52) U.S. Cl. CPC F02D 41/2454; F02D 19/029; F02D 19/084; F02D 19/087; F02D 41/0027; F02D 41/062; F02D 41/2483; F02M 21/0215

(57) ABSTRACT

In a fuel injection control device, a learning value compensating for a steady deviation between actual air-fuel ratio and target air-fuel ratio is updated through an air-fuel ratio feedback control during engine operation, and a fuel injection amount is corrected using the learning value. If fuel having been replenished is detected at the time of engine starting, a correction amount is added to the learning value. Here, in a case where the learning value is a value which is included in a predetermined range, the correction amount is set to “0” and engine starting is performed by using the learning value as it is. Meanwhile, in a case where the learning value is a value which is not included in the predetermined range, the learning value is corrected to a value equal to a boundary value of the predetermined range by the correction amount, and engine starting is performed.

### BACKGROUND OF THE INVENTION

1. Field of the Invention

The invention relates to a fuel injection control device for controlling a fuel injection amount.

2. Description of Related Art

In a fuel injection control device described in Japanese Patent Application Publication No. 2000-170581 (JP 2000-170581 A), a learning value compensating for a steady deviation between an actual air-fuel ratio and a target air-fuel ratio is updated through an air-fuel ratio feedback control during engine operation, and a fuel injection amount is corrected by using the learning value.

If fuel which is different in a fuel property from fuel stored in a fuel tank is replenished, the fuel property of the fuel stored in the fuel tank varies before fuel replenishment and after fuel replenishment. For this reason, if in an engine operation after fuel replenishment, a fuel injection amount is corrected by using the learning value updated before fuel replenishment, there is a concern that poor combustion may occur due to the actual air-fuel ratio being deviated from the target air-fuel ratio.

In the fuel injection control device described in JP 2000-170581 A, the stored learning value is cleared and replaced with a substitute value on the condition that a poor combustion state is detected.

### SUMMARY OF THE INVENTION

In the fuel injection control device described in JP 2000-170581 A, in a case where a poor combustion state is detected, the stored learning value is cleared, and therefore, at the time of the start of fuel injection using fuel after fuel replenishment, there is a concern that poor combustion may still occur.

A fuel injection control device capable of switching fuel which is used during engine operation is also known. However, in such a fuel injection control device, not only when starting an engine, but also when switching fuel which is used during engine operation and starting fuel injection using fuel after replenishment, there is a concern that poor combustion may likewise occur.

In a case where gaseous fuel such as natural gas, alcohol mixed fuel in which a fuel property changes according to alcohol concentration, or the like is used as fuel, the fuel property of fuel which is replenished is often not constant. For this reason, such a problem easily occurs particularly in a case of using gaseous fuel or a case of using alcohol mixed fuel.

The present invention provides a fuel injection control device in which it is possible to prevent poor combustion from occurring due to the replenishment of fuel which is different in fuel property from fuel which is stored, at the time of the start of fuel injection using fuel after the fuel replenishment.

According to a first aspect of the present invention, there is provided a fuel injection control device including: an electronic control unit configured to (a) update and store a learning value compensating for a steady deviation between an actual air-fuel ratio and a target air-fuel ratio through an air-fuel ratio feedback control during operation of an engine, (b) correct a fuel injection amount by using the learning value, (c) detect whether or not fuel is replenished, (d) start fuel injection .by using a stored learning value and fuel after being replenished, when the stored learning value at a timing when the electronic control unit determines that fuel is replenished is included in a predetermined range from a first predetermined value to a second predetermined value, the first predetermined value being a value used when an amount increase correction of fuel is performed, the second predetermined value being a value used when an amount decrese correction of fuel is performed, and (e) correct the stored learning value to a value in the predetermined range and start fuel injection by using fuel after being replenished, when the stored learning value at the timing vvhen the electronic control unit determines that fuel is replenished is not included in the predetermined range.

In a case where fuel stored in a fuel tank is fuel having a fuel property in which an air-fuel ratio is shifted toward the rich side, the learning value is updated to a value on the amount decrease correction side through, a feedback control. In contrast, in a case where the fuel is fuel having a fuel property in which an air-fuel ratio is shifted toward the lean side, the learning value is updated to a value on the amount increase correction side through the feedback control. Then, in a case where the fuel property of the fuel stored in the fuel tank is significantly biased toward the rich side or the lean side, the learning value also becomes a value significantly biased toward the amount increase correction side or the amount decrease correction side, and thus a correction amount of the fuel injection amount increases.

When the stored learning value is significantly biased toward the amount increase correction side, in a case where fuel replenishment is performed, and thus the fuel property stored in the fuel tank changes from the lean side to the rich side, the fuel injection amount becomes excessive at the time of the start of fuel injection using fuel after the fuel replenishment, and the air-fuel ratio is significantly shifted toward the rich side, and thus poor combustion occurs. Further, when the stored learning value is significantly biased toward the amount decrease correction side, in a case where fuel replenishment is performed, and thus the fuel property stored in the fuel tank changes from the rich side to the lean side, the fuel injection amount is insufficient at the time of the start of fuel injection using fuel after the fuel replenishment, and the air-fuel ratio is significantly shifted toward the lean side, and thus poor combustion occurs.

According to the above configuration, in a case where the learning value stored at the point in time when fuel has been replenished is biased toward the amount increase correction side or the amount decrease correction side enough to exceed the predetermined range, the learning value is corrected to a value in the predetermined range.

For this reason, even if the fuel property in the fuel tank changes due to performing fuel replenishment, it is possible to prevent occurrence of poor combustion by preventing the air-fuel ratio at the time of the start of fuel injection using fuel after fuel replenishment from being significantly shifted toward the rich side or the lean side.

Further, in the above fuel injection control device, when the learning value stored at the point in time when fuel has been replenished is a value in the predetermined range and is not very biased toward the amount increase correction side or the amount decrease correction side, the correction of the stored learning value is not performed and the stored learning value is maintained as it is.

In the learning value, in addition to a steady shift of the air-fuel ratio due to a difference in the fuel property of fuel which is used, a steady shift of the air-fuel ratio due to a shift of the fuel injection amount due to manufacturing variation, a temporal change, or the like of a component such as a fuel injection valve is also reflected. Therefore, it is not preferable to recklessly correct the learning value each time fuel is replenished.

According to the above configuration, in a case of being in a situation in which the learning value stored at the point in time when fuel has been replenished is not very biased toward the amount increase correction side or the amount decrease correction side and it is difficult for poor combustion to occur even if the learning value stored before fuel replenishment is used as it is, the learning value stored before fuel replenishment is maintained as it is even at the time of the start of fuel injection using fuel after fuel replenishment. Therefore, it is possible to prevent occurrence of poor combustion at the time of the start of fuel injection using fuel after fuel replenishment, without recklessly correcting the learning value with a steady shift of the air-fuel ratio including factors other than a fuel property reflected therein.

As a boundary value on the amount increase correction side of the predetermined range, for example, a limit value on the amount increase correction side of the learning value in which it is possible to perform engine operation even if the richest fuel is injected may be adopted. The first predetermined value may be a limit value when the engine operates even in a case where fuel containing combustible components in a predetermined amount or more is used.

In a case where fuel having⁻a fuel property in which the air-fuel ratio is shifted toward the rich side is injected in a state where the learning value is a value on the amount increase correction side, the fuel injection amount becomes excessive, and thus poor combustion easily occurs. On the contrary, according to the above configuration, the boundary value on the amount increase correction side of the predetermined range is the limit value on the amount increase correction side of the learning value in which it is possible to perform engine operation even if the richest fuel that is fuel in which the air-fuel ratio is shifted toward the richest side, and the richest fuel can be replenished, is injected. Then, in a case where the learning value stored at the point in time when fuel has been replenished is a value further on the amount increase correction side than the predetermined range, the stored learning value is corrected to a value in the predetermined range. For this reason, even if the property of fuel in the fuel tank changes due to the replenishment of fuel and thus becomes a fuel property in which the air-fuel ratio is shifted toward the rich side, it is difficult for the fuel injection amount to become excessive, and thus it is possible to prevent poor combustion at the time of the start of fuel injection using fuel after fuel replenishment.

Further, in a case, where the limit value on the amount increase correction side of the learning value in which it is possible to perform engine operation even if the richest fuel is injected, as described above, is adopted as the boundary value on the amount increase correction side of the predetermined range, for example, when fuel having been replenished is detected by a detection section and the learning value stored at the point in time when fuel has been replenished is a value when performing an amount increase correction more than the predetermined range, the stored learning value may be corrected to a value equal to the first predetermined value.

According to the above configuration, the learning value is corrected to a value in which even if the richest fuel is injected, it is difficult for the fuel injection amount to become excessive, and thus it is possible to make the correction amount of the learning value as small as possible even while preventing the fuel injection amount from becoming excessive due to a change in a fuel property due to replenishment. Therefore, it is possible to minimize the correction amount of the learning value and make the characteristic of the learning value before correction with a steady shift of the air-fuel ratio including factors other than a fuel property reflected therein be reflected in the learning value after correction as much as possible.

As a boundary value on the amount decrease correction side of the predetermined range, for example, a limit value on the amount decrease correction side of the learning value in which it is possible to perform engine operation even if the leanest fuel is injected may be adopted. The second predetermined value may be a limit value when the engine operates even in a case where fuel containing inert components in a predetermined amount or more is used.

In a case where fuel having a fuel property in which the air-fuel ratio is shifted toward the lean side is injected in a state where the learning value is a value on the amount decrease correction side, the fuel injection amount is insufficient, and thus poor combustion easily occurs. In contrast, according to the above configuration, the boundary value on the amount decrease correction side of the predetermined range is the limit value on the amount decrease correction side of the learning value in which it is possible to perform engine operation even if the leanest fuel that is fuel in which the air-fuel ratio is shifted toward the leanest side, and the leanest fuel can be replenished, is injected. Then, in a case where the learning value stored at the point in time when fuel has been replenished is a value further on the amount decrease correction side than the predetermined range, the stored learning value is corrected to a value in the predetermined range: For this reason, even if the fuel property of fuel in the fuel tank changes due to the replenishment of fuel and thus becomes a fuel property in which the air-fuel ratio is shifted toward the lean side, it is difficult for the fuel injection amount to become insufficient, and thus it is possible to prevent poor combustion at the time of the start of fuel injection using fuel after fuel replenishment.

Further, in a case where the limit value on the amount decrease correction side of the learning value in which it is possible to perform engine operation even if the leanest fuel is injected, as described above, is adopted as the boundary value on the amount decrease correction side of the predetermined range, for example, when fuel having been replenished is detected by the detection section and the learning value stored at the point in time when fuel has been replenished is a value when performing an amount decrease correction more than the predetermined range, the stored learning value may be corrected to a value equal to the second predetermined value.

According to the above configuration, the learning value is corrected to a value in which even if the leanest fuel is injected, it is difficult for the fuel injection amount to become insufficient, and thus it is possible to make the correction amount of the learning value as small as possible even while preventing the fuel injection amount from becoming insufficient due to a change in fuel property due to replenishment. Therefore, it is possible to minimize the correction amount of the learning value and make the characteristic of the learning value before correction with a steady shift of the air-fuel ratio including factors other than a fuel property reflected therein be reflected in the learning value after correction as much as possible.

Further, the predetermined range may be made wider as, for example, the ratio of a fuel replenishment amount to a fuel storage amount is lower. The lower the ratio of the fuel replenishment amount to the fuel storage amount after fuel replenishment, the smaller a change in fuel property due to fuel replenishment becomes.

According to the above configuration, a predetermined range that is a range in which the correction of the learning value is not performed becomes wider as a change in fuel property is smaller. For this reason, a change in fuel property is small, and thus even if the learning value is not corrected, when the possibility of engine operation being performed by starting fuel injection using fuel after fuel replenishment is high, the predetermined range is made wide, and thus it becomes difficult for the correction of the learning value to be performed. That is, according to the above configuration, it is possible to increase or decrease an opportunity to correct the learning value in accordance with the degree of change in fuel property due to fuel replenishment, and it is possible to prevent excessive correction of the learning value.

According to a second aspect of the present invention, there is provided a fuel injection control device including: an electronic control unit configured to (a) update and store a learning value compensating for a steady deviation between an actual air-fuel ratio and a target air-fuel ratio through an air-fuel ratio feedback control during operation of an engine, (b) correct a fuel injection amount by using the learning value, (c) detect whether or not fuel is replenished, (d) start fuel injection using fuel after being replenished and a fuel injection amount corrected based on a stored learning value when the stored learning value at a timing when the electronic control unit determines that fuel is replenished is included in a predetermined range from a first predetermined value to a second predetermined value, the first predetermined value being a value used when an amount increase correction of fuel is performed, the second predetermined value being a value used when an amount decrease correction of fuel is performed, and (e) start fuel injection using fuel after being replenished and a fuel injection amount in a predetermined injection amount range when the stored learning value at a timing when the electronic control unit determines that fuel is replenished is not included in the predetermined range, the predetermined injection amount range being a range of a fuel injection amount corrected by the learning value in the predetermined range.

As described above, in a case where when the stored learning value is significantly biased toward the amount increase correction side, fuel replenishment is performed, and thus a fuel property stored in the fuel tank changes from the lean side to the rich side, the fuel injection amount becomes excessive at the time of the start of fuel injection using fuel after fuel replenishment, and the air-fuel ratio is significantly shifted toward the rich side, and thus poor combustion occurs. Further, in a case where when the stored learning value is significantly biased toward the amount decrease correction side, fuel replenishment is performed, and thus the fuel property stored in the fuel tank changes from the rich side to the lean side, the fuel injection amount is insufficient at the time of the start of fuel injection using fuel after the fuel replenishment, and the air-fuel ratio is significantly shifted toward the lean side, and thus poor combustion occurs.

In the above configuration, in a case where the learning value stored at the point in time when fuel has been replenished is biased toward, the amount increase correction side or the amount decrease correction side enough to exceed the predetermined range, the fuel injection amount is corrected to a fuel injection amount in a predetermined injection amount range.

For this reason, even if the fuel property in the fuel tank changes due to fuel replenishment being performed, it is possible to prevent occurrence of poor combustion by preventing the air-fuel ratio at the time of the start of fuel injection using fuel after fuel replenishment from being significantly shifted toward the rich side, or the lean side.

Further, in the above fuel injection control device, when the learning value stored at the point in time when fuel has been replenished is a value in the predetermined range and is not very biased toward the amount increase correction side or the amount decrease correction side, fuel is injected by using the fuel injection amount with a correction to the amount increase side or the amount decrease side by the stored learning value performed thereon.

As described above, in the learning value, in addition to a steady shift of the air-fuel ratio due to a difference in the fuel property of fuel which is used, a steady shift of the air-fuel ratio due to a shift of the fuel injection amount due to manufacturing variation, a temporal change, or the like of a component such as the fuel injection valve is also reflected. Therefore, in the fuel injection amount corrected by using the learning value, a steady shift of the air-fuel ratio due to various factors including factors other than a fuel property is reflected. Therefore, it is not preferable to recklessly correct the fuel injection amount corrected by using the learning value.

According to the above configuration, in a case of being in a situation in which the learning value stored at the point in time when fuel has been replenished is not very biased toward the amount increase correction side or the amount decrease correction side and it is difficult for poor combustion to occur even if the fuel injection amount corrected by using the learning value stored before fuel replenishment is used as it is, the fuel injection amount corrected by using the learning value is used as it is. Therefore, it is possible to prevent occurrence of poor combustion at the time of the start of fuel injection using fuel after fuel replenishment, without recklessly correcting the fuel injection amount corrected by using the learning value with ,a steady shift of the air-fuel ratio including factors other than a fuel property reflected therein.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram showing schematic configurations of a fuel injection control device of an embodiment and an internal combustion engine;

FIG. 2 is a flowchart showing the processing procedure of correction processing;

FIG. 3 is a map which defines the relationship between a learning value at the point in time when fuel has been replenished and a correction amount of the learning value by the correction processing; and

FIG. 4 is a map which defines the relationship between the learning value at the point in time when fuel has been replenished and the correction amount of the learning value by the correction processing in another embodiment.

### DETAILED DESCRIPTION OF EMBODIMENTS

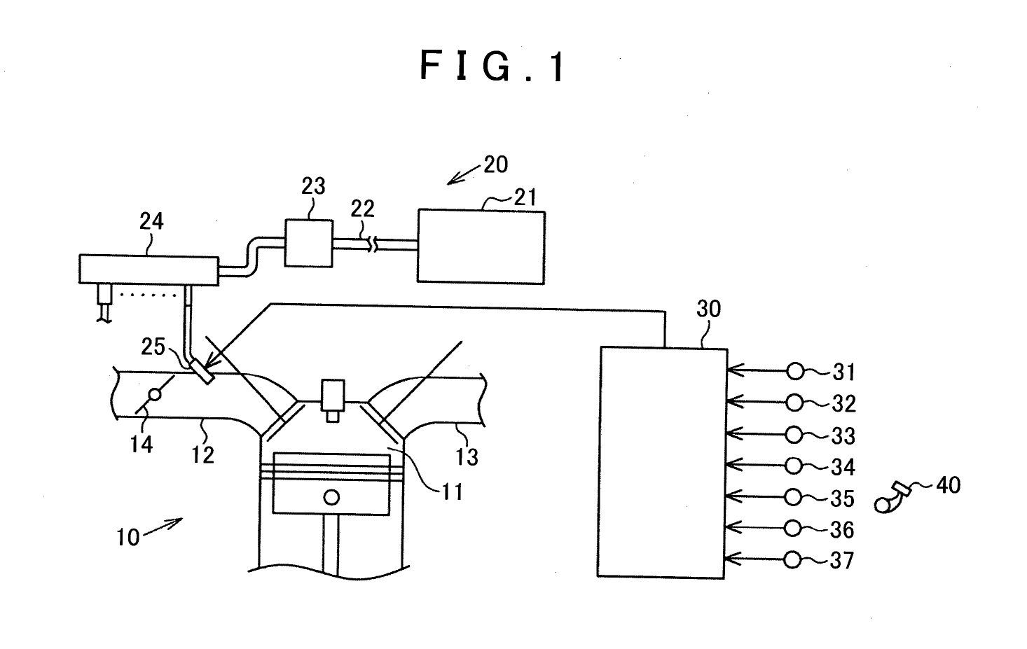

Hereinafter, an embodiment of a fuel injection control device will be described with reference to FIGS. 1 to 3. As shown in FIG. 1, in an intake passage 12 of an internal combustion engine 10, a throttle valve 14, an opening degree of which is adjusted according to an accelerator operation aspect, and a fuel injection valve 25 which injects fuel are provided. An air-fuel mixture composed of intake air having passed through the throttle valve 14 and fuel injected from the fuel injection valve 25 is supplied to a combustion chamber 11 and burned in the combustion chamber 11.

A fuel injection control device 20 supplies compressed natural gas (CNG) that is an example of gaseous fuel to the internal combustion engine 10 as fuel by the fuel injection valve 25. In the fuel injection control device 20, the fuel supplied from a fuel tank 21 which stores CNG therein to fuel piping 22 is supplied from the fuel piping 22 to a delivery pipe 24 through a pressure regulator 23. Then, the fuel is supplied from the delivery pipe 24 to the fuel injection valve 25, whereby the fuel is injected from the fuel injection valve 25 into the intake passage 12.

In the internal combustion engine 10, various sensors for detecting an operating state thereof, switches, and the like are provided. As the various sensors, for example, a rotational speed sensor 31 for detecting the rotational speed of a crankshaft (an engine speed), an air flow meter 32 for detecting the amount of air which is sucked into the combustion chamber 11 (a suction air amount), and a water temperature sensor 33 for detecting the temperature of cooling water (a cooling water temperature) of the internal combustion engine 10 are provided. Further, an air-fuel ratio sensor 34 which detects oxygen concentration of exhaust gas in an exhaust passage 13, and an accelerator sensor 35 for detecting an, operation amount of an accelerator pedal 40 (an accelerator operation amount) are provided. Then, a pressure sensor 36 which detects the internal pressure of the fuel tank 21, and an ignition switch 37 which is operated when starting the internal combustion engine 10 or when stopping the internal combustion engine 10 are provided. In addition, as described above, the fuel injection control device 20 uses CNG that is gaseous fuel as fuel, and therefore, the smaller the amount of fuel stored in the fuel tank 21 (a fuel storage amount) becomes, the lower the internal pressure of the fuel tank 21 becomes. Therefore, the pressure sensor 36 functions as a detection section which detects the amount of fuel stored in the fuel tank 21 (the fuel storage amount).

Output signals of these various sensors are input to an electronic control unit 30 which executes a fuel injection control for controlling the fuel injection valve 25, as described later, thereby functioning as a portion of the fuel injection control device 20. The electronic control unit 30 is provided with a central processing unit (CPU) and a memory. In the memory, various control programs, a map which is referred to when executing these various control programs, and the like are stored. Further, in the electronic control unit 30, various calculations are performed based on the output signals of the various sensors and various engine controls relating to an operation of the internal combustion engine 10 are executed based on the calculation results.

As the various engine controls, a fuel injection control for controlling the fuel injection valve 25 can be given as an example. In the fuel injection control, a basic fuel injection amount for making an air-fuel ratio of the air-fuel mixture be a desired ratio (for example, a theoretical air-fuel ratio) is calculated based on an engine load and an engine speed and the product obtained by multiplying the basic fuel injection amount by the sum of a feedback correction coefficient KF and a learning value KG is calculated as a fuel injection amount. In addition, the engine load is calculated based on the suction air amount and the engine speed.

The feedback correction coefficient KF and the learning value KG are calculated through an air-fuel ratio feedback control during engine operation. The calculation of the feedback correction coefficient KF is performed based on a difference between an actual air-fuel ratio which is determined from oxygen concentration that is detected by the air-fuel ratio sensor 34 (an actual air-fuel ratio) and a target air-fuel ratio. Specifically, in a case where the actual air-fuel ratio is a value further on the rich side than the target air-fuel ratio, a predetermined amount is subtracted from the feedback correction coefficient KF, and in a case where the actual air-fuel ratio is a value on the lean side, a predetermined amount is added to the feedback correction coefficient KF. Further, the learning of the learning value KG which is a value reflecting a steady deviation between the actual air-fuel ratio and the target air-fuel ratio is executed based on the feedback correction coefficient KF calculated in this way. Then, a steady deviation amount between the feedback correction coefficient KF and its basic value (=“1.0”) is compensated by the learning value KG. In addition, the learning processing of the learning value KG is executed if the feedback correction coefficient KF deviates from the basic value by a predetermined amount. In the learning processing of the learning value KG, the updating of the learning value KG is performed by calculating the average value of the feedback correction coefficient KF in the most recent predetermined period and adding a value obtained by subtracting “1.0” from the average value, to the learning value KG. The updated learning value KG is stored in the memory of the electronic control unit 30. If the updating of the learning value KG is performed in this way, the feedback correction coefficient KF is reset to the basic value.

Then, in the fuel injection control, as described above, the stored learning value KG is added to the feedback correction coefficient KF and the sum and the basic fuel injection amount are multiplied together, whereby the basic fuel injection amount is corrected. A value obtained by correcting the basic fuel injection amount in this way is calculated as a fuel injection amount. Then, fuel injection time, that is, opening time of the fuel injection valve 25 is calculated based on the fuel injection amount and the fuel injection valve 25 is driven so as to be opened, based on the fuel injection time. In this way, fuel in an amount equivalent to the fuel injection amount is injected from the fuel injection valve 25, thereby being supplied to the combustion chamber 11 of the internal combustion engine 10.

Here, CNG contains methane as its main component. However, there is a case where in addition to a combustible component such as propane except for methane, a lot of inert gases which do not contribute to combustion,. such as nitrogen or carbon dioxide, are also contained therein. As the degree of influence on the air-fuel ratio characteristics in gaseous fuel material such as CNG, that is, as an index indicating a fuel property, there is a Wobbe index W. The Wobbe index W is an index which is defined by Equation (1) below by using a calorific value H per unit mass of fuel and a specific gravity A of fuel on the basis of air.

W=H/VA . . . (1). Then, the relationship between the Wobbe index W and an excess air ratio λ is defined by Equation (2) below.

λ∝1/W . . . (2). That is, according to the above Equations (1) and (2), for example, CNG in which the content of inert gas is small is large in Wobbe index W, and CNG in which the content of inert gas is large is small in Wobbe index W. In CNGs which are different in Wobbe index W from each other in this manner, the excess air ratios also become different from each other.

For this reason, if CNG which is different in Wobbe index W from the CNG stored in the fuel tank 21 is replenished to the fuel tank 21, the Wobbe index W of the CNG stored in the fuel tank 21 varies before fuel replenishment and after fuel replenishment.

For example, in a case where CNG stored in the fuel tank 21 has a fuel property in which the Wobbe index W is large and the air-fuel ratio is shifted toward the rich side, the learning value KG is updated to a value on the amount decrease correction side through the air-fuel ratio feedback control. In contrast, in a case where CNG stored in the fuel tank 21 is fuel having a fuel property in which the Wobbe index W is small and the air-fuel ratio is shifted toward the lean side, the learning value KG is updated to a value on the amount increase correction side through the air-fuel ratio feedback control. Then, in a case where the Wobbe index W of CNG stored in the fuel tank 21 is significantly small or large and the fuel property thereof is significantly biased toward the lean side or the rich side, the learning value KG also becomes a value significantly biased toward the amount increase correction side or the amount decrease correction side, and thus a correction amount of the fuel injection amount is increased.

If CNG which is small in Wobbe index W is replenished to the fuel tank 21 in a situation in which the learning value KG is updated as a value on the amount decrease correction side, the excess air ratio λ of CNG which is injected from the fuel injection valve 25 increases. For this reason, if the fuel injection amount is corrected based on the learning value KG stored after fuel replenishment, the actual air-fuel- ratio is shifted from the target air-fuel ratio to the lean side. In particular, in a case where when the stored learning value KG is significantly biased toward the amount decrease correction side, fuel replenishment is performed, and thus the fuel property of CNG stored in the fuel tank 21 changes to the lean side, the fuel injection amount is insufficient when starting fuel injection using fuel after fuel replenishment, and the air-fuel ratio is significantly shifted toward the lean side, and thus poor combustion occurs.

Further, if CNG which is large in Wobbe index W is replenished to the fuel tank 21 in a situation in which the learning value KG is updated as a value on the amount increase correction side, the excess air ratio λ of CNG which is injected from the fuel injection valve 25 decreases. For this reason, if the fuel injection amount is corrected based on the learning value KG stored after fuel replenishment, the actual air-fuel ratio is shifted from the target air-fuel ratio to the rich side. In particular, in-a case where when the stored learning value KG is significantly biased toward the amount increase correction side, fuel replenishment is performed, and thus the fuel property of CNG stored in the fuel tank 21 changes to the rich side, the fuel injection amount becomes excessive when starting fuel injection using fuel after fuel replenishment, and the air-fuel ratio is significantly shifted toward the rich side, and thus poor combustion occurs.

Therefore, in this embodiment, the stored learning value KG is corrected by performing correction processing by the electronic control unit 30. Hereinafter, the correction processing will be described. In addition, the correction processing is executed by the electronic control unit 30 on the condition that it is at the time of engine starting, that is, on the condition that the ignition switch 37 has been operated from an engine stop state.

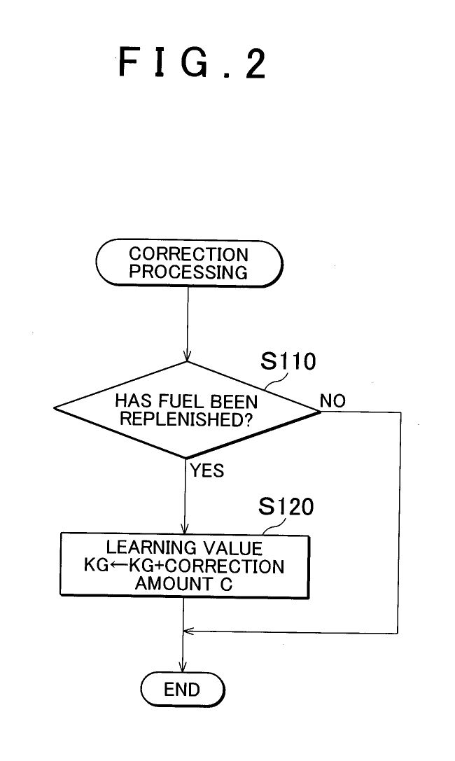

As shown in FIG. 2, if the correction processing is started, first, whether or not fuel has been replenished to the fuel tank 21 is determined (Step S110). Here, a determination that fuel has been replenished to the fuel tank 21 is made on the condition that a determination that the fuel storage amount of the fuel tank 21 has increased to greater than or equal to a predetermined amount during engine stop is made based on a detection value of the pressure sensor 36. In a case where a determination that an increase amount of the fuel storage amount of the fuel tank 2,1 is less than a predetermined amount is made, it is assumed that fuel is not replenished to the fuel tank 21 (Step S110: NO), and thus this processing is temporarily ended.

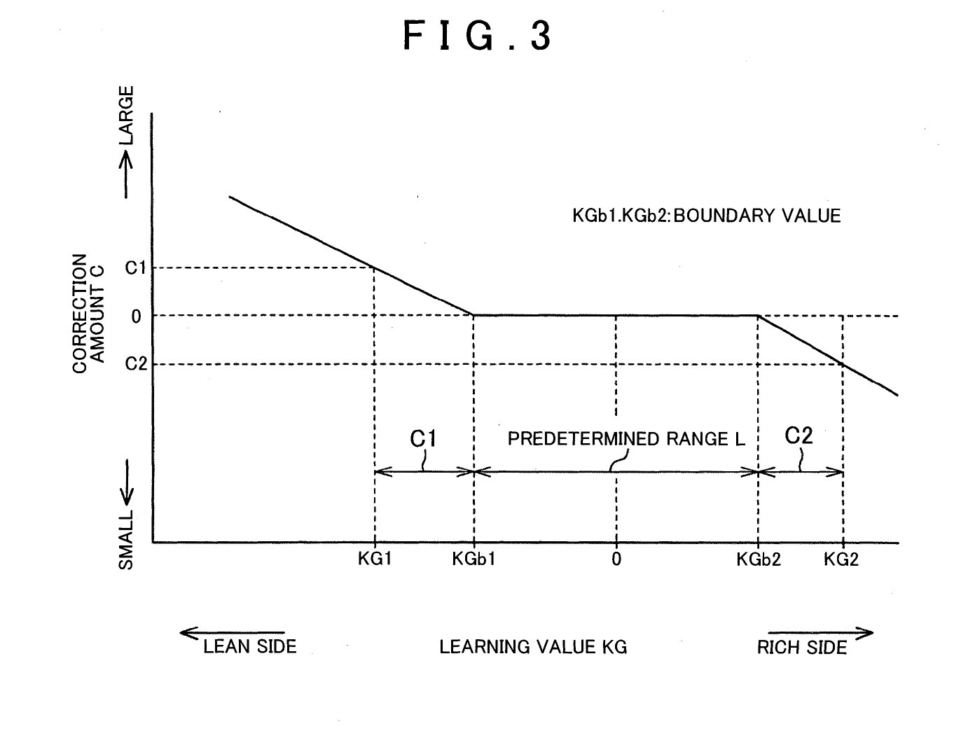

In a case where the fuel storage amount of the fuel tank 21 has increased to greater than or equal to a predetermined amount, a determination that fuel has been replenished to the fuel tank 21 is made (Step S110: YES), and a correction amount C is added to the stored learning value KG (Step S120). The magnitude of the correction amount C is set based on a map shown in FIG. 3 in which the relationship between the stored learning value KG and the correction amount C is defined.

As shown in FIG. 3, according to the map, in a case where the learning value KG stored at the time of engine starting, that is, stored at the point in time when fuel has been replenished to the fuel tank 21 is a value which is included in a predetermined range L, “0” (zero) is set as the correction amount C. That is, in a case where the learning value KG stored at the time of engine starting is a value further on the amount increase correction side (hereinafter referred to as a rich side) than a boundary value KGb1 on the amount decrease correction side (hereinafter referred to as a lean side) of the predetermined range L and is a value further on the lean side than a boundary value KGb2 on the rich side of the predetermined range L, “0” (zero) is set as the correction amount. Further, also in a case where the learning value KG stored at the time of engine starting is a value equal to the boundary value KGb1 of the predetermined range L or a value equal to the boundary value KGb2, “0” (zero) is set as the correction amount. If “0” (zero) is set as the correction amount C in this manner, even if the correction amount C is added to the stored learning value KG, the learning value KG is not corrected. For this reason, in this case, fuel injection using fuel after fuel replenishment is stated by using the learning value KG stored before fuel replenishment as it is, and thus engine starting is performed.

In contrast, in a case where the learning value KG stored at the time of engine starting is significantly biased toward the lean side and is a value further on the lean side than the boundary value KGb1 on the lean side of the predetermined range L, a value greater than “0” (zero) is set as the correction amount C according to the stored learning value KG In addition, in the map shown in FIG. 3, in a case where the learning value KG stored at the time of engine starting is a value further on the lean side than the, boundary value KGb1, the learning value KG is corrected to the boundary value KGb1 by the correction of the correction amount C. For example, as shown in FIG. 3, when the learning value KG stored at the time of engine starting is a predetermined value KG1 that is a value further on the lean side than the boundary value KGb1, a predetermined amount C1 that is a value larger than “0” (zero) is set as the correction amount C. Then, the set predetermined amount C1 is added to the stored learning value KG In this way, the learning value KG is updated to the boundary value KGb1 that is the learning value KG further on the rich side than the learning value KG stored before fuel replenishment. Further, in a case where the stored learning value KG is larger in shift from the boundary value KGb1 to the lean side than the predetermined value. KG1, a value larger than the predetermined amount C1 is set as the correction amount C. In a case where the stored learning value KG is smaller in shift from the boundary value KGb1 to the lean side than the predetermined value KG1, a value smaller than the predetermined amount C1 is set as the correction amount C. Then, the correction amount C set in this manner is added to the stored learning value KG, whereby the learning value KG is updated to the boundary value KGb1. In this manner, in a case where the learning value KG stored at the time of engine starting is a value further on the lean side than the boundary value KGb1, the magnitude of the correction amount C is set such that such a shift is eliminated, according to the amount of shift of the stored learning value KG from the boundary value KGb1 to the lean side. Then, the correction of the stored learning value KG is performed by the set correction amount C, and fuel injection using fuel after fuel replenishment is started by using the corrected learning value KG, and thus engine starting is performed.

Further, in a case where the learning value KG stored at the time of engine starting is significantly biased toward the rich side and is a value further on the rich side than the boundary value KGb2 on the rich side of the predetermined range L, a value smaller than “0” (zero) is set as the correction amount C according to the stored learning value KG. In addition, in the map shown in FIG. 3, in a case where the learning value KG stored at the time of engine starting is a value further on the rich side than the boundary value KGb2, the learning value KG is corrected to the boundary value KGb2 by the correction of the correction amount C. For example, as shown in FIG. 3, when the learning value KG stored at the time of engine starting is a predetermined value KG2 that is a value further on the rich side than the boundary value KGb2, a predetermined amount C2 that is a value smaller than “0” (zero) is set as the correction amount C. Then, the set predetermined amount C2 is added to the stored learning value KG. In this way, the learning value KG is updated to the boundary value KGb2 that is the learning value KG further on the lean side than the learning value KG stored before fuel replenishment. Further, in a case where the stored learning value KG is larger in shift from the boundary value KGb2 to the rich side than the predetermined value KG2, a value smaller than the predetermined amount C2 is set as the, correction amount C. In a case where the stored learning value KG is smaller in shift from the boundary value. KGb2 to the rich side than the predetermined value KG2, a value larger than the predetermined amount C2 is set as the correction amount C. Then, the correction amount C set in this manner is added to the stored learning value KG, whereby the learning value KG is updated to the boundary value KGb2. In this manner, in a case where the learning value KG stored at the time of engine starting is a value further on the rich side than the boundary value KGb2, the magnitude of the correction amount C is set such that such a shift is eliminated, according to the amount of shift of the stored learning value KG from the boundary value KGb2 to the rich side. Then, the correction of the stored learning value KG is performed by the set correction amount C, and fuel injection using fuel after fuel replenishment is started by using the corrected learning value KG, and thus engine starting is performed.

In addition, the boundary value KGb1 on the lean side of the predetermined range L is set to a limit value on the lean side of the learning value KG in which even if the leanest fuel is injected, it is possible to perform engine starting, that is, it is possible to perform the first engine operation after fuel replenishment to the fuel tank 21 is made. The leanest fuel is CNG having a property in which the content of inert gas such as nitrogen or carbon dioxide is the greatest, among CNG capable of being replenished, and is equivalent to CNG in which the excess air ratio X becomes the largest in a case where the same amount is burned under the same conditions. Then, the limit value on the lean side of the learning value KG in which it is possible to perform engine operation in a case of injecting the leanest fuel is calculated by an experiment or the like, and the calculated limit value is set as the boundary value KGb1.

Further, the boundary value KGb2 on the rich side of the predetermined range L is set to a limit value on the rich side of the learning value KG in which even if the richest fuel is injected, it is possible to perform engine starting, that is, it is possible to perform the first engine operation after fuel replenishment to the fuel tank 21 is made.

The richest fuel is CNG having a property in which the content of inert gas such as nitrogen or carbon dioxide is the smallest and the content of a combustible component such as propane is the greatest, among CNG capable of being replenished, and is equivalent to CNG in which the excess air ratio X becomes the smallest in a case where the same amount is burned under the same conditions. Then, the limit value on the rich side of the learning value KG in which it is possible to perform engine operation in a case of injecting the richest fuel is calculated by an experiment or the like, and the calculated limit value is set as the boundary value KGb2.

After the correction amount C set based on the map shown in FIG. 3 in this way is added to the learning value KG, this processing is temporarily ended. In the fuel injection control device 20 of this embodiment, the stored learning value KG is corrected through such correction processing.

Next, an operation by the fuel injection control device 20 of this embodiment will be described. In a case where fuel having been replenished through the correction,processing described with reference to FIG. 2 is detected and the learning value KG stored at the point in time when fuel has been replenished is biased toward the rich side or the lean side enough to exceed the predetermined range L, the correction amount C is added, whereby the learning value KG is corrected to a value equal to the boundary value KGb1 or KGb2 of the predetermined range L. In contrast, in a case where fuel having been replenished through the correction processing described with reference to FIG. 2 is detected and the learning value KG stored at the point in time when fuel has been replenished is a value in the predetermined range L, the correction amount C is made to be “0” (zero). As a result, the correction of the stored learning value KG is not performed and the stored learning value KG is maintained as, it is.

According to the fuel injection control device 20 described above, the following effects can be exhibited. (1) In a case where fuel having been replenished is detected and the learning value KG stored at the point in time when fuel has been replenished is biased toward the rich side or the lean side enough to exceed the predetermined range L, the learning value KG is corrected to a value equal to the boundary value KGb1 or KGb2 of the predetermined range L.

For this reason, even if the fuel property of fuel in the fuel tank 21 changes due to fuel replenishment being performed, it is possible to prevent occurrence of poor combustion by preventing the air-fuel ratio at the time of the start of fuel injection using fuel after fuel replenishment from being significantly shifted toward the rich side or the lean side.

(2) When the learning value KG stored at the point in time when fuel has been replenished is a value in the predetermined range L and is not very biased toward the rich side or the lean side, the correction of the stored learning value KG is not performed and the stored learning value KG is maintained as it is.

In the learning value KG, in addition to a steady shift of the air-fuel ratio due to a difference in the fuel property of fuel which is used, a steady shift of the air-fuel ratio due to a shift of the fuel injection amount due to manufacturing variation, a temporal change, or the like of a component such as the fuel injection valve 25 is also reflected. Therefore, it is not preferable to recklessly correct the learning value KG each time fuel is replenished.

According to the fuel injection control device 20 described above, in a case of being in a situation in which it is difficult for poor combustion to occur even if the learning value KG stored at the point in time when fuel has been replenished is used as it is, the learning value KG stored before fuel replenishment is maintained as it is even at the time of the start of fuel injection using fuel after fuel replenishment. Therefore, it is possible to prevent occurrence of poor combustion at the time of the start of fuel injection using fuel after fuel replenishment, without recklessly correcting the learning value KG , with a steady shift of the air-fuel ratio including factors other than a fuel property reflected therein.

(3) In a case where fuel having a fuel property in which the air-fuel ratio is shifted toward the rich side is injected in a state where the learning value KG is a value on the rich side, the fuel injection amount becomes excessive, and thus poor combustion easily occurs. On the contrary, according to the fuel injection control device 20 described above, the boundary value KGb2 on the rich side of the predetermined range L becomes the limit value on the rich side of the learning value KG in which it is possible to perform engine operation even if the richest fuel that is fuel in which the air-fuel ratio is shifted toward the richest side, and the richest fuel can be replenished, is injected. Then, in a case where the learning value KG stored at the point in time when fuel has been replenished is a value further on the rich side than the predetermined range L, the stored learning value KG is corrected to a value in the predetermined range L. For this reason, even if the fuel property of fuel in the fuel tank 21 changes due to the replenishment of fuel and thus becomes a fuel property in which the air-fuel ratio is shifted toward the rich side, it is difficult for the fuel injection amount to become excessive, and thus it is possible to prevent poor combustion at the time of the start of fuel injection using fuel after fuel replenishment.

(4) The learning value KG is corrected to a value equal to the boundary value KGb2 that is a value in which even if the richest fuel is injected, it is difficult for the fuel injection amount to become excessive. In this way, it is possible to make the correction amount of the learning value KG as small as possible in comparison with, for example, a case of correcting the learning value KG to a value further on the lean side than the boundary value KGb2 in the predetermined range L, while preventing the fuel injection amount from becoming excessive due to a change in fuel property due to the replenishment of fuel. Therefore, it is possible to minimize the correction amount of the learning value KG and to make the characteristic of the learning value KG before correction with a steady shift of the air-fuel ratio including factors other than a fuel property reflected therein be reflected in the learning value KG after correction as much as possible.

(5) In a case where fuel having a fuel property in which the air-fuel ratio is shifted toward the lean side is injected in a state where the learning value KG is a value on the lean side, the fuel injection amount is insufficient, and thus poor combustion easily occurs. On the contrary, according to the fuel injection control device 20 described above, the boundary value KGb1 on the lean side of the predetermined range L becomes the limit value on the lean side of the learning value KG in which it is possible to perform engine operation even if the leanest fuel that is fuel in which the air-fuel ratio is shifted toward the leanest side, and the leanest fuel can be replenished, is injected. Then, in a case where the learning value KG stored at the point in time when fuel has been replenished is a value further on the lean side than the predetermined range L, the stored learning value KG is corrected to a value in the predetermined range L. For this reason, even if the fuel property of fuel in the fuel tank 21 changes due to the replenishment of fuel and thus becomes a fuel property in which the air-fuel ratio is shifted toward the lean side, it is difficult for the fuel injection amount to become insufficient, and thus it is possible to prevent poor combustion at the time of the start of fuel injection using fuel after fuel replenishment.

(6) The learning value KG is corrected to a value equal to the boundary value KGb1 that is a value in which even if the leanest fuel is injected, it is difficult for the fuel injection amount to become insufficient. In this way, it is possible to make the correction amount of the learning value KG as small as possible in comparison with, for example, a case of correcting the learning value KG to a value further on the rich side than the boundary value KGb1 in the predetermined range L, while preventing the fuel injection amount from becoming insufficient due to a change in fuel property due to the replenishment of fuel. Therefore, it is possible to minimize the, correction amount of the learning value KG and make the characteristic of the learning value KG before correction with a steady shift of the air-fuel ratio including factors other than a fuel property reflected therein be reflected in the learning value KG after correction as much as possible.

In addition, the above-described embodiment can also be modified and implemented as follows. In a case where the learning value KG stored at the point in time when fuel has been replenished is a value further on the rich side than the predetermined range L, a value which is set as the correction amount C may not be a value to correct the learning value KG to the boundary value KGb2 of the predetermined range L For example, a value to correct the stored.learning value KG to the value of the learning value KG shifted slightly further to the lean side than the boundary value KGb2 may be set as the correction amount C. Further, a value to correct the stored learning value KG to the value (in the above-described embodiment, “0” (zero)) of the neutral learning value KG which is biased toward neither the rich side nor the lean side may be set as the .correction amount C. In short, the magnitude of the correction amount C can be freely set as long as it is a value to correct the stored learning value KG to a value in the predetermined range L. According to such a modified example, it is possible to exhibit the same effects as the effects (1) to (3), (5), and (6) which can be obtained in the above-described embodiment.

In a case where the learning value KG stored at the point in time when fuel has been replenished is a value further on the lean side than the predetermined range L, a value which is set as the correction amount C may not be a value to correct the learning value KG to the boundary value KGb1 of the predetermined range L. For example, a value to correct the stored learning value KG to the value of the learning value KG shifted slightly further to the rich side than the boundary value KGb1 may be set as the correction amount C. Further, a value to correct the stored learning value KG to the value (in the above-described embodiment, “0” (zero)) of the neutral learning value KG which is biased toward neither the rich side nor the lean side may be set as the correction amount C. In short, the magnitude of the correction amount C can be freely set as long as it is a value to correct the stored learning value KG to a value in the predetermined range L. According to such a modified example, it is possible to exhibit the same effects as the effects (1) to (5) which can be obtained in the above-described embodiment.

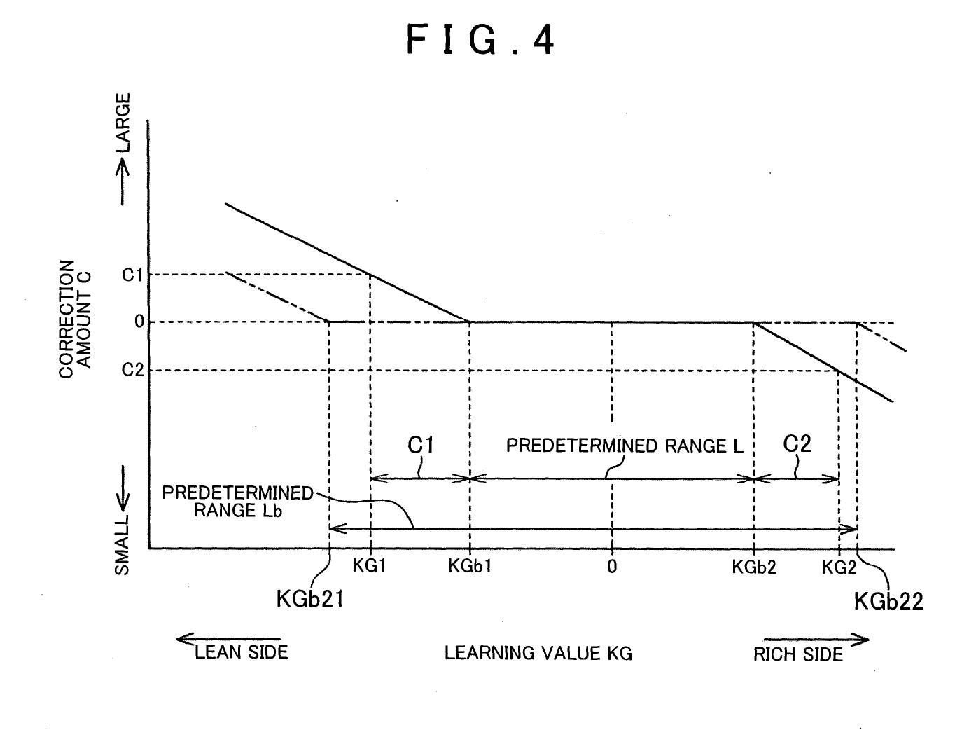

The correction amount C of the learning value KG may be set using a map shown in FIG. 4. In the map shown in FIG. 4, the relationship between the learning value KG and the correction amount C when the ratio of the fuel replenishment amount in the fuel storage amount is 100% is shown by a solid line. Further, the relationship between the learning value KG and the correction amount C when the ratio of the fuel replenishment amount in the fuel storage amount is 50% is shown by a two-dot chain line. In addition, in FIG. 4; only the relationships between the learning value KG and the correction amount C when the ratios of the fuel replenishment amount are 100% and 50% are illustrated. However, in the actual map, the relationship between the learning value KG and the correction amount C is set for each case where the fuel replenishment amount is a predetermined ratio such as 10%. When the ratio of the fuel replenishment amount is 100%, a range from the boundary value KGb1 on the lean side to the boundary value KGb2 on the rich side is set as the predetermined range L. Then, the correction amount C is set in the same manner as the above-described embodiment according to the learning value KG stored at the point in time when fuel has been replenished. In contrast, when the ratio of the fuel replenishment amount is 50%, a range from a boundary value KGb21 on the lean side to a boundary value KGb22 on the rich side is set as a predetermined range Lb. Then, in a case where the learning value KG stored at the point in time when fuel has been replenished is a value which is included in the predetermined range Lb, “0” (zero) is set as the correction amount C, whereby the correction of the learning value KG is not performed and the stored learning value KG is used as it is. In a case where the learning value KG stored at the point in time when fuel has been replenished is a value which is not included in the predetermined range Lb, a value larger than “0” (zero) or a value smaller than “0” (zero) is set as the correction amount C, as shown by a two-dot chain line, and the correction of the learning value KG is performed based on the correction amount C. The boundary value KGb21 of the predetermined range Lb is a value further on the lean side than the boundary value KGb1 of the predetermined range L. Further, the boundary value KGb22 of the predetermined range Lb is a value further on the rich side than the boundary value KGb2 of the predetermined range L. In this manner, in this modified example, the lower the ratio of the fuel replenishment amount to the fuel storage amount, the wider the above-described predetermined range relating to the setting of the correction amount C becomes. According to such a modified example, in addition to the same effects as the effects (1) and (2) which can be obtained in the above-described embodiment, the following effects can be exhibited.

(7) The lower the ratio of the fuel replenishment amount to the fuel storage amount after fuel replenishment, the smaller a change in fuel property due to fuel replenishment becomes. According to this modified example, a predetermined range that is a range in which the correction of the learning value KG is not performed becomes wider as a change in the fuel property of fuel which is stored in the fuel tank 21 is smaller. For this reason, a change in fuel property is small, and thus even if the learning value KG is not corrected, when the possibility of engine operation being performed by starting fuel injection using fuel after fuel replenishment is high, a predetermined range is made wide, and thus it becomes difficult for the correction of the learning value KG to be performed. That is, according to the above-described modified example, it is possible to increase or decrease an opportunity to correct the learning value KG in accordance with the degree of change in fuel property due to fuel replenishment, and it is possible to prevent excessive correction of the learning value KG.

The learning value KG may be corrected by subtracting the correction amount C from the learning value. KG. In such a modified example, as a map for setting the correction amount C, a map in which the relationship between the learning value KG and the correction amount C is set to an inverse relationship with the map shown in FIG. 3 or 4 is used. That is, the correction amount C when the learning value KG is a value further on the rich side than the predetermined range L is changed to a positive value, and the correction amount C when the learning value KG is a value further on the lean side than the predetermined range L is changed to a negative value.

The learning value KG may be corrected by multiplying the learning value KG by the correction amount C. A map for setting the correction amount C which is used in such a modified example is a map in which the correction amount C when the learning value KG is a value in the predetermined range L is changed to “1” in the map shown in FIG. 3 or 4. Further, the correction amount C when the learning value KG is a value further on the rich side than the predetermined range L is changed to a positive value smaller than “1”, and the correction amount C when the learning value KG is a value further on the lean side than the predetermined range L is changed to a value larger than “1”.

The learning value KG may be corrected by dividing the learning value KG by the correction amount C. A map for setting the correction amount C which is used in such a modified example is a map in which the correction amount C when the learning value KG is a value in the predetermined range L is changed to “1” in the map shown in FIG. 3 or 4. Further, the correction amount C when the learning value KG is a value further on the rich side than the predetermined range L is changed to a value large than “1”, and the correction amount C when the learning value KG is a value further on the lean side than the predetermined range L is changed to a positive value smaller than “1”.

Instead of the correction of the learning value KG based on the learning value KG, the fuel injection amount may be corrected. Specifically, separately from the feedback correction coefficient KF or the learning value KG, a correction term NF for correcting the fuel injection amount is set. Then, the correction term NF is set according to the learning value KG stored at the time of engine starting, that is, stored at the point in time when fuel has been replenished, on the condition that fuel replenishment has been made, and the fuel injection amount is corrected. When the stored learning value KG is a value in the predetermined range L, the correction term NF is set to a value which does not correct the fuel injection amount to the amount increase side or the amount decrease side. If the correction term NF is set in this manner, the correction of the fuel injection amount by the correction term NF is not performed and fuel is injected by using the fuel injection amount in which a correction to the amount increase side or the amount decrease side by the stored learning value KG is performed. In contrast, when the stored learning value KG is a value shifted further to the lean side than the boundary value on the lean side of the predetermined range L, the correction term NF is set to a size to perform a correction to increase the fuel injection amount. Then, when the stored learning value KG is a value shifted further to the rich side than the boundary value on the rich side of the predetermined range L, the correction term NF is set to a size to perform a correction to decrease the fuel injection amount. If the size of the correction term NF is set in this manner, the fuel injection amount is corrected by the correction term NF so as to become the fuel injection amount when having been corrected by the learning value KG in the predetermined range L. That is, when a range of the corrected fuel injection amount corresponding to the predetermined range L of the learning value KG is set to be a predetermined injection amount range, fuel injection using fuel after fuel replenishment is started by using the fuel injection amount in the predetermined injection amount range. In addition, the predetermined injection amount range is a range from the fuel injection amount that is the least in amount, of the fuel injection amount which is calculated by a correction using the learning value KG in the predetermined range L, to the fuel injection amount that is the largest in amount. Further, the correction term NF gradually approaches a value which does not correct the fuel injection amount, for each predetermined period during engine operation after the start of fuel injection using fuel after fuel replenishment, and after the elapse of a predetermined period of time from the start of fuel injection using fuel after fuel replenishment, the correction term NF becomes a value which does not correct the fuel injection amount to the amount increase side or the amount decrease side. According to such a modified example, the following effects can be exhibited.

(8) As described above, in a case where when the stored learning value KG is significantly biased toward the rich side, fuel replenishment is performed and thus the fuel property of fuel stored in the fuel tank 21 changes from the lean side to the rich side, the fuel injection amount becomes excessive at the time of the start of fuel injection using fuel after fuel replenishment, and the air-fuel ratio is significantly shifted toward the rich side, and thus poor combustion occurs. Further, in a case where when the stored learning value KG is significantly biased toward the lean side, fuel replenishment is performed and thus the fuel property of fuel stored in the fuel tank 21 changes from the rich side to the lean side, the fuel injection amount is insufficient at the time of the start of fuel injection using fuel after fuel replenishment, and the air-fuel ratio is significantly shifted toward the lean side, and thus poor combustion occurs.

According to the above-described modified example, in a case where the learning value KG stored at the point in time when fuel has been replenished is biased toward the rich side or the lean side enough to exceed the predetermined range, the fuel injection amount is corrected to a fuel injection amount in the predetermined injection amount range.

For this reason, even if the fuel property of fuel in the fuel tank 21 changes due to fuel replenishment being performed, it is possible to prevent occurrence of poor combustion by preventing the air-fuel ratio at the time of the start of fuel injection using fuel after fuel replenishment from being significantly shifted toward the rich side or the lean side.

(9) In the fuel injection control device 20 according to the above modified example, when the learning value KG stored at the point in time when fuel has been replenished is a value in a predetermined range and is not very biased toward the rich side or the lean side, fuel is injected by using a fuel injection amount with a correction to the amount increase side or the amount decrease side by the stored learning value KG performed thereon.

As described above, in addition to a steady shift of the air-fuel ratio due to a difference in the fuel property of fuel which is used, a steady shift of the air-fuel ratio due to, a shift of the fuel injection amount due to manufacturing variation, a temporal change, or the like of a component such as the fuel injection valve 25 is also reflected in the learning value KG. Therefore, in the fuel injection amount corrected by using the learning value KG, a steady shift of the air-fuel ratio due to various factors including factors other than a fuel property is reflected. Therefore, it is not preferable to recklessly correct the fuel injection amount corrected by using the learning value KG.

According to the above-described modified example, in a case of being in a situation in which it is difficult for poor combustion to occur even if the fuel injection amount corrected by using the learning value KG stored before fuel replenishment is used as it is, the fuel injection amount corrected by using the learning value KG is used as it is. Therefore, it is possible to prevent occurrence of poor combustion at the time of the start of fuel injection using fuel after fuel replenishment, without recklessly correcting the fuel injection amount corrected by using the learning value KG with a steady shift of the air-fuel ratio including factors other than a fuel property reflected therein.

As the boundary value KGb2 on the rich side of the predetermined range L, values other than the limit value on the rich side of the learning value KG in which it is possible to perform engine operation even if the richest fuel is injected may be set. For example, assuming that predetermined rich fuel having a fuel property shifted slightly further to the lean side than the richest fuel is injected, a limit value on the rich side of the learning value KG in which it is possible to perform engine operation even if such injection is made may be set as the boundary value KGb2. According to such a modified example, it is possible to exhibit the same effects as the effects (1), (2), (5), and (6) which can be obtained in the above-described embodiment.

As the boundary value KGb1 on the lean side of the predetermined range L, values other than the limit value on the lean side of the learning value KG in which it is possible to perform engine operation even if the leanest fuel is injected may be set. For example, assuming that predetermined lean fuel having a fuel property shifted slightly further to the rich side than the leanest fuel is injected, a limit value on the lean side of the learning value KG in which it is possible to perform engine operation even if such injection is made may be set as the boundary value KGb1. According to such a modified example, it is possible to exhibit the same effects as the effects (1) to (4) which can be obtained in the above-described embodiment.

The fuel injection amount may be calculated by multiplying the basic fuel injection amount by a value obtained by multiplying the stored learning value KG by the feedback correction coefficient KF. In such a form, the value of the neutral learning value KG which is biased toward neither the rich side nor the lean side becomes “1”, a value on the rich side becomes a value larger than “1”, and a value on the lean side becomes a value smaller than “1”.

A method of calculating the correction amount of the learning value KG or the fuel injection amount is not limited to the calculation using a map. If it is possible to correct the learning value KG or the fuel injection amount in the same aspect as in the above-described embodiment or each modified example, the method of calculating the correction amount can also be appropriately changed.

A configuration may be made such that when the stored learning value KG is a value in the predetermined range L, the calculation of the correction amount of the learning value KG or the fuel injection amount is not performed, and when the stored learning value KG is a value outside of the predetermined range L, the correction amount of the learning value KG or the fuel injection amount is calculated.

In a case where gaseous fuel such as natural gas, alcohol mixed fuel, the fuel property of which changes according to alcohol concentration, or the like is used as fuel, the fuel property of fuel which is replenished is not often constant. For this reason, it is also possible to apply the technical idea illustrated in the above-described embodiment or each modified example to a fuel injection control device in which instead of CNG, gaseous fuels other than CNG, or alcohol mixed fuel is used as fuel, and it is possible to exhibit the same effects. In addition, in a case of using alcohol mixed fuel as fuel, it is preferable to detect whether or not fuel has been replenished, by using a float or the like which detects a fuel level in a fuel tank, instead of the pressure sensor 36.

It is also possible to apply the technical idea illustrated in the above-described embodiment or each modified example to a fuel injection control device capable of performing injection by switching a plurality of fuels, and it is possible to exhibit the same effects. It is also possible to apply the technical idea illustrated in the above-described embodiment or each modified example to, for example, a fuel injection control device in which it is possible to switch used fuel between CNG and gasoline during engine operation.

In the fuel injection control device in which switching of use fuel is possible, the learning value is updated for each fuel. That is, the learning value for fuel which is used is updated at the time of engine operation using the respective fuels. Then, the fuel injection amounts of the respective fuels are corrected by using the learning value updated for each type of fuel.

For this reason, for example, in a case where the same technical idea is applied to a fuel injection control device in which it is possible to perform injection by switching between CNG and gasoline, when fuel having been replenished is detected and the learning value for the fuel stored at the point in time when the fuel has been replenished is not included in a predetermined range, the learning value or the fuel injection amount is corrected. In this way, when during engine operation, use fuel is switched to fuel having been replenished, it is possible to start fuel injection using fuel after fuel replenishment, with an appropriate fuel injection amount.

In addition, when gaseous fuel such as CNG in which a fuel property of fuel which is replenished is not often constant or alcohol fuel has been replenished, such a correction according to whether or not the learning value stored at the point in time of replenishment is included in a predetermined range is performed, and when fuel such as gasoline in which variation in fuel property is less has been replenished, a correction may not be performed.

1. A fuel injection control device comprising:
an electronic control unit configured to
(a) update and store a learning value compensating for a steady deviation between an actual air-fuel ratio and a target air-fuel ratio through an air-fuel ratio feedback control during operation of an engine,
(b) correct a fuel injection amount by using the learning value,
(c) detect whether or not fuel is replenished,
(d) start fuel injection by using a stored learning value and fuel after being replenished, when the stored learning value at a timing when the electronic control unit determines that fuel is replenished is included in a predetermined range from a first predetermined value to a second predetermined value, the first predetermined value being a value used when an amount increase correction of fuel is performed, the second predetermined value being a value used when an amount decrease correction of fuel is performed, and
(e) correct the stored learning value to a value in the predetermined range and start fuel injection by using fuel after being replenished, when the stored learning value at the timing when the electronic control unit determines that fuel is replenished is not included in the predetermined range.

2. The fuel injection control device according to claim 1, wherein the first predetermined value is a limit value when the engine operates even in a case where the richest fuel is used, the richest fuel is fuel in which an air-fuel ratio is shifted toward the richest side, and the richest fuel can be replenished.

3. The fuel injection control device according to claim 2, wherein the electronic control unit is configured to correct the stored learning value to a value equal to the first predetermined value when the stored learning value at a timing when the electronic control unit determines that fuel is replenished is a value used when the amount increase correction is performed beyond the predetermined range.

4. The fuel injection control device according to claim 1, wherein the second predetermined value is a limit value when the engine operates even in a case where the leanest fuel is used, the leanest fuel is fuel in which an air-fuel ratio is shifted toward the leanest side, and the leanest fuel can be replenished.

5. The fuel injection control device according to claim 4, wherein the electronic control unit is configured to correct the stored learning value to a value equal to the second predetermined value when the stored learning value at a timing when the electronic control unit determines that fuel is replenished is a value used when the amount decrease correction is performed beyond the predetermined range.

6. The fuel injection control device according to claim 1, wherein the electronic control unit is configured to set the predetermined range to be wider as a ratio of a fuel replenishment amount to a fuel storage amount is lower.

7. A fuel injection control device comprising:
an electronic control unit configured to
(a) update and store a learning value compensating for a steady deviation between an actual air-fuel ratio and a target air-fuel ratio through an air-fuel ratio feedback control during operation of an engine,
(b) correct a fuel injection amount by using the learning value,
(c) detect whether or not fuel is replenished,
(d) start fuel injection using fuel after being replenished and a fuel injection amount corrected based on a stored learning value when the stored learning value at a timing when the electronic control unit determines that fuel is replenished is included in a predetermined range from a first predetermined value to a second predetermined value, the first predetermined value being a value used when an amount increase correction of fuel is performed, the second predetermined value being a value used when an amount decrease correction of fuel is performed, and
(e) start fuel injection using fuel after being replenished and a fuel injection amount in a predetermined injection amount range when the stored learning value at a timing when the electronic control unit determines that fuel is replenished is not included in the predetermined range, the predetermined injection amount range being a range of a fuel injection amount corrected by the learning value in the predetermined range.
